(19) United States
(12) Patent Application Publication
(10) Pub. No.: US 2026/0003942 A1
(43) Pub. Date: Jan. 1, 2026

(54) INFORMATION PROCESSING DEVICE, SYSTEM, AND PROGRAM

(71) Applicant: AlphaTheta Corporation, Yokohama-shi, Kanagawa (JP)

(72) Inventor: Hiroyuki Hasegawa, Yokohama-shi, Kanagawa (JP)

(21) Appl. No.: 18/870,032

(22) PCT Filed: Jun. 13, 2022
(86) PCT No.: PCT/JP2022/023589

§ 371 Date: Nov. 27, 2024

(51) Int. Cl. G06F 21/31

(52) U.S. Cl. CPC G06F 21/31

(57) ABSTRACT

An information processing device includes a determining section configured to check first authentication information based on a user input against second authentication information received from DJ equipment and including operation information for the DJ equipment, and to perform user authentication based on a matching result.

### TECHNICAL FIELD

The present invention relates to an information processing device, a system, and a program.

### BACKGROUND ART

In recent years, music distribution via the Internet has become common, and various related technologies are being considered for DJ equipment. When using the Internet, it is necessary to take security into consideration. For instance, Patent Literature 1 discloses a recording/playback device that allows a valid user to easily remove the prohibition on use by utilizing personal identification information.

### CITATION LIST

### Patent Literature(s)

Patent Literature 1: JP 2006-65894 A

### SUMMARY OF THE INVENTION

### Problem(s) to be Solved by the Invention

When it comes to DJ equipment, multiple users (DJs) often use the same equipment, so the user authentication technique that takes security into consideration is particularly important. In view of the above, for instance, a user authentication technique using an ID and a password, a user authentication technique using an external memory device, and a user authentication technique using a mobile device are used. However, such conventional user authentication techniques have problems such as being time-consuming and cumbersome, and requiring advance preparation, and therefore there is a demand for a safer and more user-friendly user authentication technique.

The invention aims to solve at least part of the above problems. An object of the invention is to provide an information processing device, a system, and a program that can perform user authentication safely and easily.

### Means for Solving the Problem(s)

An information processing device according to an aspect of the invention includes a determining section configured to check first authentication information based on a user input against second authentication information received from DJ equipment and including operation information for the DJ equipment, and to perform user authentication based on a matching result.

A system according to another aspect of the invention includes: the above-described information processing device, a terminal device configured to receive a user input, and DJ equipment configured to receive a user operation, in which the determining section is configured to check the first authentication information based on the user input to the terminal device against the second authentication information received from the DJ equipment.

A program according to still another aspect of the invention causes a computer to function as the above-described information processing device.

### BRIEF DESCRIPTION OF DRAWINGS

FIG. 1 schematically illustrates an arrangement of a system according to an exemplary embodiment.

FIG. 2 schematically illustrates an outline of a user authentication process in the system of the exemplary embodiment.

FIG. 3 is a flowchart for a process executed by a controller of a server of the exemplary embodiment.

FIG. 4 is a flowchart for another process executed by the controller of the server of the exemplary embodiment.

FIG. 5 is a flowchart for a process executed by a controller of a terminal device of the exemplary embodiment.

FIG. 6 illustrates an example of authentication information displayed on a display of the terminal device of the exemplary embodiment.

FIG. 7 is a flowchart for another process executed by the controller of the terminal device of the exemplary embodiment.

FIG. 8 is a flowchart for a process executed by a controller of an operation device of the exemplary embodiment.

FIG. 9A illustrates an example of an operation status displayed on a display of the operation device of the exemplary embodiment.

FIG. 9B illustrates an example of an authentication result displayed on the display of the operation device of the exemplary embodiment.

FIG. 10 is a flowchart for still another process executed by the controller of the server of the exemplary embodiment.

### DESCRIPTION OF EMBODIMENT(S)

Referring to the drawings, an exemplary embodiment of the invention will be described below.

### Schematic Arrangement of System

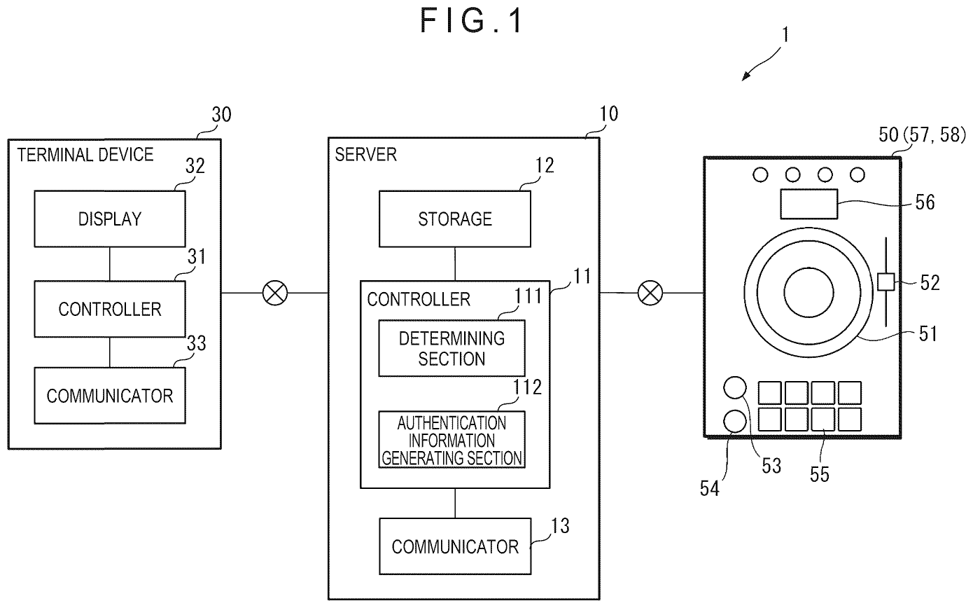

FIG. 1 schematically illustrates an arrangement of a system 1 according to the exemplary embodiment.

As illustrated in FIG. 1, the system 1 according to the exemplary embodiment includes a server 10, a terminal device 30, and an operation device 50. The server 10 is a server (e.g. a cloud server) connected in a manner in communication with the terminal device 30 and the operation device 50 via the Internet network and/or wireless network. The server 10 is provided with libraries each of which is predetermined for a corresponding user. Music data uploaded by users, and the like are stored in the libraries.

In the system 1, a user can download the music data and the like uploaded to the server 10 to the operation device 50 by operating the operation device 50. Subsequently, the user can browse the library, play the music, and perform a DJ performance, and the like with the use of the downloaded music data and the like by operating the operation device 50.

In such a process, user authentication is required to determine which user's library is to be acquired. In particular, in DJ booths and the like, a given operation device 50 is often shared by multiple users, and the user authentication is important in such cases. In the system 1 of the exemplary embodiment, the user authentication is performed by a user operating the terminal device 30 and the operation device 50.

### Schematic Configuration of Server

As illustrated in FIG. 1, the server 10 includes a controller 11, a storage 12, and a communicator 13.

The controller 11, which is implemented in the server 10 in a form of, for instance, a communication interface, a processor (e.g. a central processing unit (CPU)), and a memory providing a working area, controls the operation of each component of the server 10. The controller 11 includes a determining section 111 and an authentication information generating section 112, which are implemented by the processor that works in accordance with a program stored in the memory or received through the communication interface.

The determining section 111 performs the above-described user authentication based on operation information received from the operation device 50.

The authentication information generating section 112 generates authentication information (first authentication information) to be used for the user authentication by the determining section 111.

Details of the determining section 111 and the authentication information generating section 112 will be described later.

The storage 12 is provided with libraries each of which is predetermined for a corresponding user. Information uploaded from outside such as music data is stored in the storage 12. Each library is stored in association with a user identifier (e.g. a user ID) that can identify the user.

The communicator 13 is interconnected with the terminal device 30 and the operation device 50 through the Internet network and/or wireless network to output or receive a variety of information.

### Schematic Configuration of Terminal Device

The terminal device 30 is provided by a computer, a smartphone, a tablet terminal, or the like. The terminal device 30 includes a controller 31, a display 32, and a communicator 33 as illustrated in FIG. 1.

The controller 31, which is implemented in the terminal device 30 in a form of, for instance, a communication interface, a processor (e.g. a CPU), and a memory providing a working area, controls the operation of each component of the terminal device 30.

The display 32 is provided with a monitor in a form of, for instance, a liquid crystal display (LCD) or an organic EL display. The display 32 is configured to display images, thus presenting a variety of information to a user. A touch panel for touch detection may be provided on a surface of the display 32.

The communicator 33 is interconnected with the server 10 through the Internet network and/or wireless network to output or receive a variety of information.

### Schematic Configuration of Operation Device

As illustrated in FIG. 1, the operation device 50 includes a jog dial 51, a tempo slider 52, a cue button 53, a play/pause button 54, a performance pad 55, and a display 56. The operation device 50 also includes a controller 57 and a communicator 58 (both not illustrated in the drawings).

The jog dial 51 is a circular rotary operator used to set a playback direction and a playback speed of the music being played. A user can perform a variety of DJ performance such as scratching and pitch bending by forwardly/reversely rotating the jog dial 51, changing the rotation speed of the jog dial 51, and the like.

The tempo slider 52 is a lever used to control the playback speed of the music being played.

The cue button 53 is a button that is pressed down when a cue point is set at a predetermined point of the music.

The play/pause button 54 is a button that is pressed down to start or stop the playback of the music.

The performance pad 55 is a versatile operator to which various functions relating to the playback control can be assigned.

As with the display 32 of the terminal device 30 described above, the display 56 is provided with a monitor in a form of, for instance, an LCD or an organic EL display. The display 56 is configured to display images, thus presenting a variety of information to a user. A touch panel for touch detection may be provided on a surface of the display 56.

The controller 57, which is implemented in the operation device 50 in a form of, for instance, a communication interface, a processor (e.g. a CPU), and a memory providing a working area, controls the operation of each component of the operation device 50.

The communicator 58 is interconnected with the server 10 through the Internet network and/or wireless network to output or receive a variety of information.

### Outline of Process in System

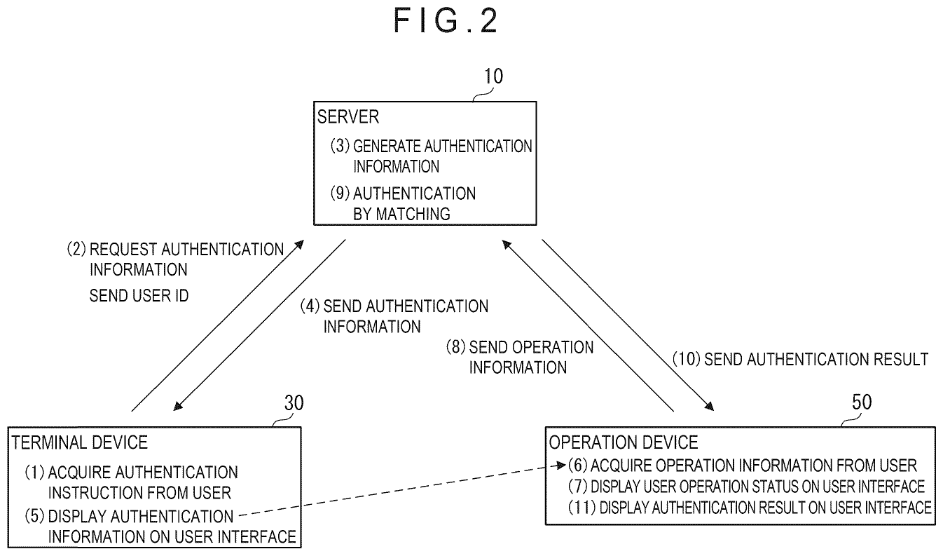

FIG. 2 schematically illustrates an outline of a user authentication process in the system 1.

In the system 1, a user operates the terminal device 30 to give an authentication instruction and operates the operation device 50 to perform an actual authentication operation.

Upon giving the authentication instruction by the user operating the terminal device 30, the terminal device 30 receives the user's authentication instruction as indicated by (1), and requests the server 10 to send authentication information as indicated by (2). The authentication instruction using the terminal device 30 is, for instance, made through a specific application or a WEB site. It should be noted that the user is authenticated to operate the terminal device 30 in a known manner before giving the authentication instruction. Further, when the terminal device 30 requests the server 10 to send the authentication information, the terminal device 30 provides the user identifier (e.g. user ID), which is information that can identify the user requesting the user authentication, to the server 10. The information that can identify the user requesting the user authentication may be the MAC address (terminal identification information) in place of or in addition to the user ID. In the following, an example is given in which the terminal device 30 sends the user ID to the server 10 when requesting the authentication information to the server 10.

When the server 10 receives the request for the authentication information from the terminal device 30, the server 10 generates the authentication information associated with the user ID as indicated by (3) and sends the authentication information to the terminal device 30 as indicated by (4).

When receiving the authentication information, the terminal device 30 displays the authentication information on a user interface as indicated by (5). The display of the authentication information on the user interface is, for instance, made through a specific application or a WEB site as described above.

In the process including (1) to (5), a user first operates the terminal device 30 to give the authentication instruction. As a result, the server 10 generates the authentication information, and the generated authentication information is displayed on the user interface of the terminal device 30.

In the authentication operation using the operation device 50, when the operation device 50 receives operation information for a user as indicated by (6), the operation device 50 displays an operation status for the user on a user interface as indicated by (7), and sends the operation information to the server 10 as indicated by (8).

When the server 10 receives the operation information, the server 10 performs the user authentication by matching as indicated by (9), and sends an authentication result to the operation device 50 as indicated by (10).

When receiving the authentication result, the operation device 50 displays the authentication result on the user interface as indicated by (11).

In the process including (6) to (11), the user visually checks the authentication information displayed on the user interface of the terminal device 30, and performs the authentication operation by operating the operation device 50. As a result, the server 10 executes the user authentication, and the authentication result is displayed on the user interface of the operation device 50.

### Process for Generating Authentication Information in Server

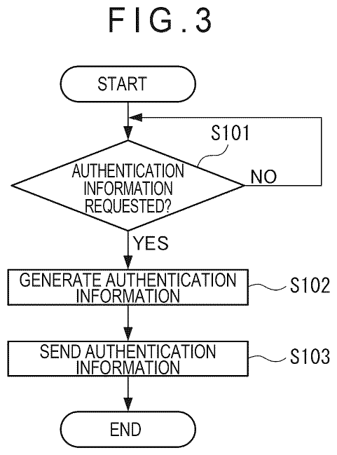

FIG. 3 is a flowchart for a process from (3) to (4) in FIG. 2, the process being executed by the controller 11 of the server 10.

When the controller 11 determines that the request for the authentication information from the terminal device 30 has been received through the communicator 13 (Step S101: YES), the authentication information generating section 112 generates the authentication information associated with the user ID (Step S102).

The authentication information, which is used for matching at the time of the user authentication, includes a combination of operations on operators provided for the operation device 50 (DJ equipment). More specifically, the authentication information includes at least one operation on any of the jog dial 51, the tempo slider 52, and the cue button 53 of the operation device 50. When a function such as a hot cue is assigned to the performance pad 55, the performance pad 55 serves as a cue button. Thus, such authentication information may be information that includes an operation on the performance pad 55.

The authentication information represents a combination of at least three elements (i.e., a type of the operator, an operation method of the operator, and an operation order of the operator as an operation target), which is a flow of a series of operations (routine).

The element of the above-described operation method for the jog dial 51 includes, for instance, how much the jog dial 51 is rotated in a clockwise direction or a counterclockwise direction. The element of the above-described operation method for the tempo slider 52 includes, for instance, how much the tempo slider 52 is slid in an upper direction (volume increasing direction) or a lower direction (volume decreasing direction). The element of the above-described operation method for the cue button 53 includes, for instance, how many times any of cue buttons 53 selected is pressed.

In response to the request from the terminal device 30, the authentication information generating section 112 generates the authentication information associated with the user ID, as described above. In generating the authentication information, the combination of the type of the operator, the operation method of the operator, and the operation order of the operator as the operation target may be determined, for instance, using a known password generation technique and/or any other technique.

The authentication information generating section 112 stores the generated authentication information in association with the user ID in, for instance, a memory (not illustrated the drawings) in the controller 11. As described above, the user ID is information that can identify the user whose authentication is requested. The user ID is supplied when the authentication information is requested from the terminal device 30.

The authentication information generating section 112 generates mutually different types of authentication information within a predetermined time. The same authentication information is thus not generated within the predetermined time. This prevents a situation in which, when the authentication information generating section 112 generates the same authentication information for different users, a confusion of the authentication information occurs in the later-described authentication process.

When multiple pieces of authentication information are generated at different timings within the predetermined time, similarity between the respective pieces of authentication information is preferably low. For instance, when generating multiple pieces of authentication information within the predetermined time, the authentication information generating section 112 differentiates, in particular, the type of the operator and the operation order of the operator as the operation target between the multiple pieces of authentication information to lower the similarity between the multiple pieces of authentication information, thereby avoiding the authentication information from being confused in the authentication process.

Then, the controller 11 sends the generated authentication information to the terminal device 30 through the communicator 13 (Step S103). The authentication information generated by the authentication information generating section 112 is provided from the server 10 to the terminal device 30, and is displayed on the user interface of the terminal device 30 to be presented to the user.

The authentication information generated as described above is used for the user authentication as a replacement for a typical password including character(s) and numeral(s).

The example is given above in which the authentication information includes at least one operation performed on any of the jog dial 51, the tempo slider 52, and the cue button 53 of the operation device 50. The authentication information may be information that includes an operation on any other operator. It should be noted that it is preferable to exclude an operator that is difficult to operate such as an operator prone to an erroneous operation. It is also preferable to exclude an operator related to, for instance, a power source system.

### Authentication Process in Server

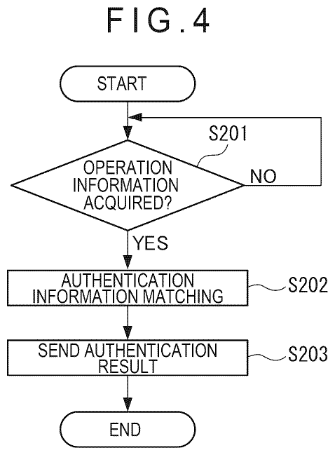

FIG. 4 is a flowchart for a process from (9) to (10) in FIG. 2, the process being executed by the controller 11 of the server 10.

When the controller 11 determines that the operation information has been received from the operation device 50 through the communicator 13 (Step S201: YES), the determining section 111 performs authentication information matching (Step S202).

The authentication information matching is performed by checking the authentication information (first authentication information) generated in association with the user ID by the authentication information generating section 112 against the authentication information (second authentication information) received from the operation device 50 (DJ equipment) and including the operation information.

Specifically, the determining section 111 performs the matching process by determining whether authentication information that matches the authentication information based on the operation information received from the operation device 50 through the communicator 13 is present in the authentication information generated by the authentication information generating section 112 and stored in association with the user ID.

Then, the controller 11 sends the authentication result to the operation device 50 through the communicator 13 (Step S203). When the matching result shows that the authentication information (first authentication information) generated in association with the user ID by the authentication information generating section 112 matches the authentication information based on the operation information for the operation device 50, the authentication result is “success.” In contrast, when the matching result shows that the authentication information (first authentication information) generated in association with the user ID by the authentication information generating section 112 does not match the authentication information (second authentication information) based on the operation information for the operation device 50, the authentication result is “failure”.

The authentication information may be of a time-dependent type in consideration of security of the authentication information generated in association with the user ID by the authentication information generating section 112. For instance, when a predetermined time has elapsed since the authentication information (first authentication information) is generated in association with the user ID by the authentication information generating section 112, the determining section 111 may invalidate user authentication based on the authentication information (first authentication information). Alternatively, for instance, when a predetermined time has elapsed since the authentication information (first authentication information) is generated in association with the user ID by the authentication information generating section 112, the authentication information may be erased. The predetermined time for the time-dependent authentication information may be determined in advance or set by a user.

### Process in Terminal Device

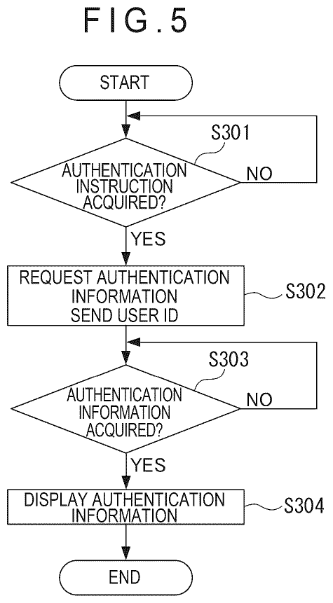

FIG. 5 is a flowchart for a process including (1), (2) and (5) in FIG. 2. the process being executed by the controller 31 of the terminal device 30.

When the controller 31 receives a user's authentication instruction via a console (not illustrated in the drawings) (Step S301: YES), the controller 31 requests authentication information from the server 10 through the communicator 33 (Step S302). At this time, the controller 31 sends the user ID, which is information that can identify the user whose authentication is requested, to the server 10.

When receiving the authentication information from the server 10 through the communicator 33 (Step S303: YES), the controller 31 displays the authentication information on the display 32 (Step S304).

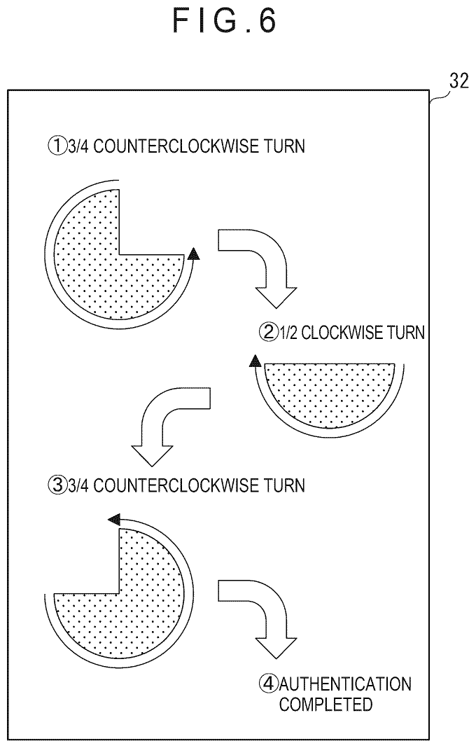

FIG. 6 illustrates an example of the authentication information displayed on the display 32. In the example illustrated in FIG. 6, the authentication information is a combination of three operations of “turn the jog dial 51 ¾ counterclockwise”, “turn the jog dial 51 ½ clockwise”, and “turn the jog dial 51 ¾ counterclockwise”. As illustrated in FIG. 6, the controller 31 displays the authentication information in a form of characters and graphics on the user interface of the display 32.

The authentication information may be displayed in a form of still images representing the flow of operations as illustrated in FIG. 6, or displayed in a form of moving images such as animation.

In the above-described example, the server 10 generates the authentication information in association with the user ID when a user operates the terminal device 30 to request the authentication information. However, in consideration of user convenience, the authentication information may be directly registered by a user's operation on the terminal device 30.

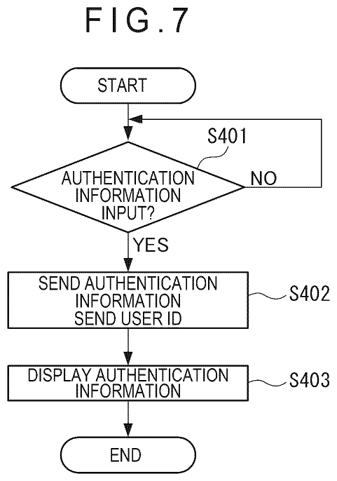

FIG. 7 is another flowchart for a process executed by the controller 31 of the terminal device 30.

When the controller 31 determines that the authentication information is input by a user via a console (not illustrated in the drawings) (Step S401: YES), the controller 31 sends the input authentication information to the server 10 through the communicator 33 (Step S402). At this time, the controller 31 sends the user ID, which is information that can identify the user whose authentication information is registered, to the server 10.

Then, the controller 31 displays the authentication information on the display 32 (Step S403).

When the server 10 receives the authentication information sent from the terminal device 30 through the communicator 13, the authentication process described with reference to FIG. 4 is performed using the received authentication information as the first authentication information.

### Process in Operation Device

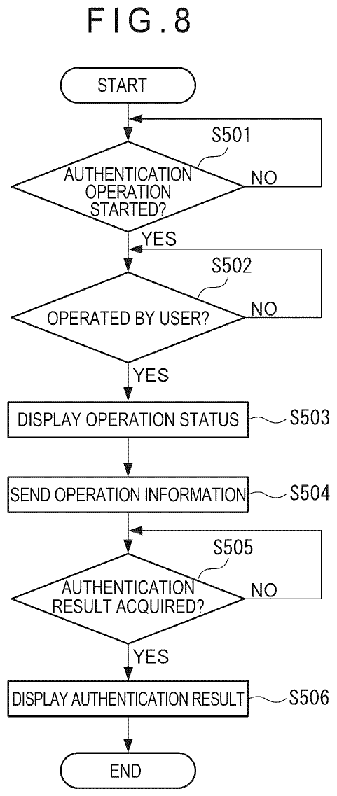

FIG. 8 is a flowchart for a process including (6) to (8) and (11) in FIG. 2, the process being executed by the controller 57 of the operation device 50.

When determining that the authentication operation has started (Step S501: YES), the controller 57 determines whether a user's operation is performed (Step S502).

In order to distinguish the authentication operation from normal operations, it is preferable to provide an operator or a UI display that allows a user to specify the start and end of the authentication.

When determining that the user's operation is performed (Step S502: YES), the controller 57 displays an operation status on the display 56 (Step S503).

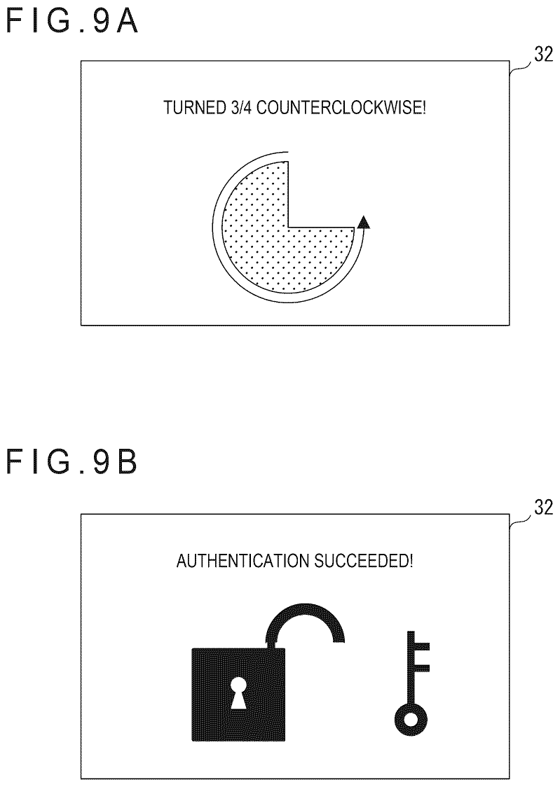

FIG. 9A illustrates an example of the operation status displayed on the display 56. In the example in FIG. 9A, a case “the jog dial 51 has been turned ¾ counterclockwise” is illustrated as the operation status. As illustrated in FIG. 9A, the controller 57 displays the operation status in a form of characters and graphics on the user interface of the display 56. In other words, the controller 57 and the display 56 function as a notifier that notifies a user of the operation status for the operation device 50.

The operation status may be displayed in a form of still images representing an operation status as illustrated in FIG. 9A, or displayed in a form of moving images such as animation.

Then, the controller 57 sends the operation information to the server 10 through the communicator 58 (Step S504). The operation information represents what operation a user performed on which operator of the operation device 50.

When the controller 57 determines that the authentication result has been received from the server 10 through the communicator 58 (Step S505: YES), the authentication result is displayed on the display 56 (Step S506).

FIG. 9B illustrates an example of the authentication result displayed on the display 56. The example of FIG. 9B illustrates that the authentication result is “success.” As illustrated in FIG. 9B, the controller 57 displays the authentication result in a form of characters and graphics on the user interface of the display 56. The same applies to a case where the authentication result is “failure.”

When the above-described user authentication succeeds, the controller 11 of the server 10 refers to the authentication information that matches the authentication information (second authentication information) received from the operation device 50 (DJ equipment) and including the operation information from among the authentication information (first authentication information) generated by the authentication information generating section 112, and the controller 11 identifies the user ID associated with the matched authentication information. The controller 11 then permits the operation device 50 to access the library associated with the identified user ID.

In other words, a user performs the user authentication by operating the operation device 50 and, once succeeding in the user authentication, the user can browse the library, play music, and perform a DJ performance, and the like with the use of the music data and the like stored in the server 10 by operating the operation device 50.

In such a user authentication, it is not necessary to associate the user ID with the operation device 50 and the operation information for the operation device 50. Accordingly, even when the operation device 50 is shared by multiple users in a DJ booth or the like, the user authentication can be safely and easily performed.

### Effects of Exemplary Embodiment

The server 10 according to the exemplary embodiment includes the determining section 111 configured to check the first authentication information based on the user input against the second authentication information received from the operation device 50 (DJ equipment) and including the operation information for the operation device 50, and to perform the user authentication based on a matching result. Such an arrangement enables safe and easy user authentication.

In particular, it is possible to reduce the amount of work involved in entering information in a known user authentication technique with the use of IDs and passwords, and to reduce the time required. Accordingly, in situations where multiple users (DJs) use the same equipment, a smooth DJ change is possible.

Further, in a known user authentication technique using an external memory device, authentication key information is written in advance in the external memory device (e.g. a USB memory), and the DJ equipment sends the key information to a server for authentication when the DJ equipment is connected to the external memory device. In contrast, the server 10 according to the exemplary embodiment does not require such an advance preparation. The user authentication is thus prevented from being impossible, which may otherwise occur if a user loses or forgets to bring the external memory device.

In a known user authentication technique using a mobile device, the user authentication is performed by entering an ID and a password displayed on the DJ equipment to the mobile device or by reading a two-dimensional code displayed on the DJ equipment with the mobile device. In contrast, the server 10 according to the exemplary embodiment reduces the amount of work involved in entering and reading the information, enabling the user authentication through a simple operation on the DJ equipment.

According to the server 10 of the exemplary embodiment, the first authentication information includes a combination of operations on the operator(s) provided for the operation device 50. This makes it possible to replace the entry of a password and the like on the DJ equipment or mobile device required for a known user authentication process, with a natural action on the DJ equipment that is familiar to a user. Accordingly, the user authentication can be performed by operating the DJ equipment, which allows a DJ, who is also a player whose every action is seen by the audience, to achieve their goal in a way that looks better and is more DJ-like. Further, compared to a known user authentication technique that requires the entry of a password, it is possible to prevent the atmosphere from being ruined or the entertainment value from being diminished.

According to the server 10 of the exemplary embodiment, the first authentication information includes at least one operation on any of the jog dial, the tempo slider, and the cue button provided for the operation device 50. Thus, user authentication can be performed with natural, good-looking, fast and smart actions on the DJ equipment that is familiar to a user.

The server 10 according to the exemplary embodiment further includes the authentication information generating section 112 configured to generate the first authentication information based on the user input and to present the first authentication information to a user. This enables safe and easy user authentication by generating the authentication information as needed in response to the user's request.

In particular, by causing the authentication information generating section 112 to generate the first authentication information in association with the user ID based on the user input, the user ID, the first authentication information, and the library that is the target for user authentication using the determining section 111, are associated with each other. This enables safe and easy user authentication based on the operation information for the operation device 50, even when the user ID is not associated with the operation device 50 and the operation information for the operation device 50.

According to the server 10 of the exemplary embodiment, the authentication information generating section 112 generates mutually different multiple pieces of first authentication information within a predetermined time. This can prevent the multiple pieces of authentication information from being duplicated or confused, even when the authentication information is requested simultaneously or at different timings by different users.

According to the server 10 of the exemplary embodiment, the determining section 111 invalidates user authentication based on the first authentication information when a predetermined time has elapsed since the first authentication information is generated by the authentication information generating section 112. The security of the authentication information can thus be improved. In particular, the DJ action is likely to be constantly seen by the audience, and is often a subject of video distribution, etc. By setting the authentication information to a time-dependent type as described above, it is possible to ensure the security of user authentication even if a third party understands the operation on the operation device 50 based on the authentication information.

The server 10 according to the exemplary embodiment further includes the notifier that notifies a user of the operation status for the operation device 50 based on the operation information. This allows the user to easily understand whether the operation on the operation device 50 is performed properly.

The system 1 according to the exemplary embodiment includes the server 10, the terminal device 30 that receives the user input, and the operation device 50 that is DJ equipment that receives the user operation. The determining section 111 of the serer 10 checks the first authentication information based on the user input to the terminal device 30 against the second authentication information received from the operation device 50. This allows the user to safely and easily perform user authentication in the server 10 by operating the terminal device 30 to give the authentication instruction and operating the operation device 50 to perform the actual authentication operation.

### Modifications of Exemplary Embodiment

The invention is not limited to the above exemplary embodiment, and modifications, improvements, and the like are within the scope of the invention, insofar as the object of the invention is achievable.

For instance, the invention may be configured to take into consideration user convenience when the user authentication fails.

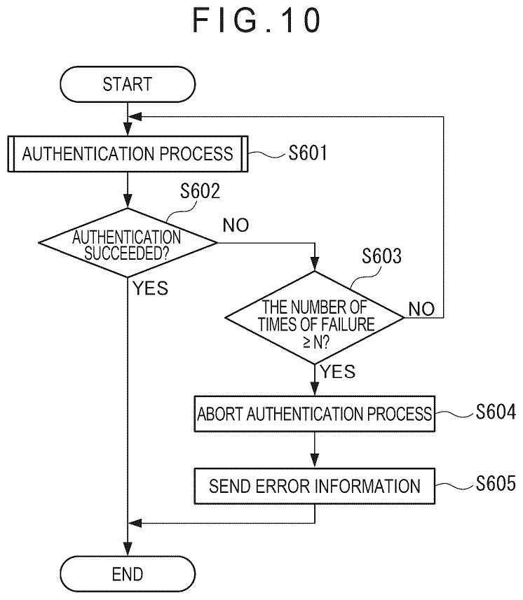

FIG. 10 is another flowchart for an authentication process executed by the controller 11 of the server 10.

The controller 11 performs the authentication process described from Steps S201 to S203 in FIG. 4 (Step S601).

The controller 11 then determines whether the authentication has succeeded (Step S602) and, when determining that the authentication has succeeded (Step S602: YES), the controller 11 terminates the authentication process.

When determining that the authentication has failed (Step S602: NO), the controller 11 determines whether the number of times of failure is equal to or greater than a predetermined threshold N (Step S603).

When determining that the number of times of the authentication failure is less than the predetermined threshold N (Step S603: NO), the controller 11 returns to Step S601, and continues the user authentication process.

When determining that the number of times of the authentication failure is equal to or greater than the predetermined threshold N (Step S603: YES), the controller 11 aborts the authentication process (Step S604) and sends error information to the operation device 50 through the communicator 13 (Step S605).

The error information may be information about the number of times user authentication has failed, information representing that the user authentication process has been aborted, or other information.

In addition, the controller 57 of the operation device 50 may be configured to display, on the display 56, information based on the error information.

When the user authentication fails a predetermined number of times or more, the user authentication based on the authentication information (first authentication information) is temporarily disabled, thereby making it possible to further improve user convenience.

Instead of temporarily disabling the user authentication based on the authentication information, the authentication method may be changed to another authentication method. For instance, when the user authentication fails a predetermined number of times or more in succession, the user authentication based on the authentication information (first authentication information) may be switched to the user authentication based on a password including character(s) and numeral(s), which has been conventionally used. Alternatively, for instance, when the user authentication fails a predetermined number of times or more in succession, a user may be allowed to select another authentication method.

When the user authentication fails a predetermined number of times or more, instead of temporarily disabling the user authentication based on the authentication information (first authentication information), new authentication information may be generated (reissued). When generating the new authentication information, the authentication information may be more sophisticated. For instance, the number of combinations of operations included in the authentication information may be increased, the type of operator used for the operation included in the authentication information may be increased, and/or the type of the operation method of the operator may be increased.

In the above exemplary embodiment, the example is given in which the user authentication process is performed by the server 10 constituting the system 1. The invention, however, is not limited thereto.

For instance, the user authentication process may be performed by any DJ equipment including the functional configurations of the server 10 and the functional configurations of the operation device 50.

In the above exemplary embodiment, the example is given in which the user authentication is performed in the server 10 based on the operation on the operation device 50. The invention, however, is not limited thereto.

For instance, part of the invention may be applied to user authentication for the operation device 50 itself. As an example, when unlocking the operation device 50, the input operation such as a known user authentication technique using an ID and a password may be replaced with a natural action on the operation device 50, as described above.

In the above exemplary embodiment, the example is given in which the authentication information includes a combination of operations on the operator(s) provided for the operation device 50 (DJ equipment). The authentication information may further include audio information. The audio information may be the presence or absence of audio input, or may be audio information related to a specific keyword.

In the above exemplary embodiment, the description is made using the operation device 50 as an example of DJ equipment. The invention, however, is not limited thereto.

For instance, the invention is similarly applicable to DJ equipment such as a player for playing music or a DJ system in which a player and a mixer that controls the player are integrated.

### Overview of the Invention

The overview of the invention is appended below.
[1] An information processing device including a determining section configured to check first authentication information based on a user input against second authentication information received from DJ equipment and including operation information for the DJ equipment, and to perform user authentication based on a matching result.

[2] The information processing device according to [1], in which the first authentication information includes a combination of operations on an operator provided for the DJ equipment.
[3] The information processing device according to [2], in which the first authentication information includes at least one operation on any of a jog dial, a tempo slider, and a cue button provided for the DJ equipment.
[4] The information processing device according to any of [1] to [3], further including an authentication information generating section configured to generate the first authentication information based on the user input and to present the first authentication information to a user.
[5] The information processing device according to [4], in which the authentication information generating section is configured to generate mutually different types of the first authentication information within a predetermined time.
[6] The information processing device according to [4] or [5], in which the determining section is configured to invalidate user authentication based on the first authentication information when a predetermined time has elapsed since the first authentication information is generated by the authentication information generating section.
[7] The information processing device according to any one of [1] to [3], further including an authentication information registering section configured to register the first authentication information based on the user input.
[8] The information processing device according to any of [1] to [7], further including a notifier configured to notify a user of an operation status for the DJ equipment based on the operation information.
[9] The information processing device according to any of [1] to [8], in which the determining section is configured to temporarily disable user authentication based on the first authentication information or to perform switching to another method of user authentication, when the user authentication fails a predetermined number of times or more.
[10] A system including: the information processing device according to any of [1] to [9], a terminal device configured to receive a user input, and DJ equipment configured to receive a user operation, in which the determining section is configured to check the first authentication information based on the user input to the terminal device against the second authentication information received from the DJ equipment.

A program causing a computer to function as the information processing device according to any of [1] to [10].

### EXPLANATION OF CODES

1 . . . system, 10 . . . server, 11, 31, 57 . . . controller, 12 . . . storage, 13, 33, 58 . . . communicator, 30 . . . terminal device, 32, 56 . . . display, 50 . . . operation device, 51 . . . jog dial, 52 . . . tempo slider, 53 . . . cue button, 54 . . . play/pause button, 55 . . . performance pad, 111 . . . determining section, 112 . . . authentication information generating section.

1. An information processing device comprising a determining section configured to check first authentication information based on a user input against second authentication information received from DJ equipment and including operation information for the DJ equipment, and to perform user authentication based on a matching result.

2. The information processing device according to claim 1, wherein the first authentication information includes a combination of operations on an operator provided for the DJ equipment.

3. The information processing device according to claim 2, wherein the first authentication information includes at least one operation on any of a jog dial, a tempo slider, and a cue button provided for the DJ equipment.

4. The information processing device according to claim 1, further comprising an authentication information generating section configured to generate the first authentication information based on the user input and to present the first authentication information to a user.

5. The information processing device according to claim 4, wherein the authentication information generating section is configured to generate mutually different types of the first authentication information within a predetermined time.

6. The information processing device according to claim 4, wherein the determining section is configured to invalidate user authentication based on the first authentication information when a predetermined time has elapsed since the first authentication information is generated by the authentication information generating section.

7. The information processing device according to claim 1, further comprising an authentication information registering section configured to register the first authentication information based on the user input.

8. The information processing device according to claim 1, further comprising a notifier configured to notify a user of an operation status for the DJ equipment based on the operation information.

9. The information processing device according to claim 1, wherein the determining section is configured to temporarily disable user authentication based on the first authentication information or to perform switching to another method of user authentication, when the user authentication fails a predetermined number of times or more.

10. A system comprising:
the information processing device according to claim 1;
a terminal device configured to receive a user input; and
DJ equipment configured to receive a user operation, wherein
the determining section is configured to check the first authentication information based on the user input to the terminal device against the second authentication information received from the DJ equipment.

11. A non-transitory computer-readable storage medium storing a program causing a computer to function as the information processing device according to claim 1.
